(19) United States
(12) Patent Application Publication
(10) Pub. No.: US 2020/0017045 A1
(43) Pub. Date: Jan. 16, 2020

(54) Safe Protection Equipment for all vehicles and drivers

(71) Applicant: Qiusheng Gao, Cupertino, CA (US)

(72) Inventor: Qiusheng Gao, Wujiang (CN)

(73) Assignee: Qiusheng Gao, Cupertino, CA (US)

(21) Appl. No.: 16/033,991

(22) Filed: Jul. 12, 2018

(51) Int. Cl. B60R 19/18; B60R 19/44

(52) U.S. Cl. CPC B60R 19/18; B60R 2019/026; B60R 19/44

(57) ABSTRACT

Safe protection equipment for all vehicles will significantly reduce the collision force by elasticity of ring and material in that the rings will be deformed and the materials of the rings will be compressed when the vehicle bumps to obstacle or two vehicles collide with each other. The reduced colliding force will be passed to the chassis that will move the vehicle forth or back. The damage to the body of the vehicle and the passengers in the vehicle will be reduced significantly. This equipment can be used on front, rear, side and corner of the vehicle. Combination of rings can reduce the collision smoothly.

This equipment will protect both vehicles and drivers without changing the current air-bag protection system. It will significantly reduce the damage for serious collision accidents.

This equipment is attached to the vehicle chassis to pass the reduced collision force to the vehicle chassis, while the current vehicle passes the collision force directly to the body of the vehicle when a collision occurs.

### TECHNICAL FIELD

The present invention generally relates to improvements in protecting both vehicles and drivers over collision accidents utilizing the elasticity of ring and material from either front, rear, side and/or corner. The rings will be deformed, and the material will be compressed to reduce the colliding force when the vehicle hits an obstacle or collides with each other. The reduced colliding force will be passed to the chassis of the vehicle. The chassis of the vehicle is almost incompressible. If the vehicle hits the obstacle, the vehicle could push the obstacle forward or the vehicle bumps back. If two vehicles hit each other, both vehicles could bump back or one vehicle pushes another vehicle forward.

There is no change for the current airbag protection system.

### BACKGROUND ART

Currently, most vehicles use airbag to protect the drivers in collision accidents. There is limitation with airbag protection. Airbag only protects driver, but not vehicle. When the vehicle hits an obstacle or collide with each other, the vehicle body and auto parts can be damaged. In case of heavy collision accident, not only the vehicles are seriously damaged, but also the drivers could be seriously injured or even killed due to the strong colliding force. Even in case the collision is not heavy, the vehicle body or auto parts are still damaged.

### SUMMARY OF THE INVENTION

An object of the present invention is to utilize the elasticity of ring made of rubber, alloy steel steal, carbon fiber or other material with high strength to reduce the colliding force and pass the reduced colliding force to the chassis to protect the vehicle and improve the protection over drivers. The current airbag protection system is not changed. Overall it will significantly reduce the damage for both vehicles and drivers in the collision accidents.

In accordance with the present invention, there are multiple rings fixed to two plates with one plate fixed to the front of a frame that is fixed to the chassis of the vehicle.

In accordance with the present invention, when the vehicle hits an obstacle or collides with another vehicle, the front plate that fixes the rings will push the rings, if the vehicle hits the obstacle or collides with another vehicle in straight line or almost in straight line. During this process, the rings will reduce the colliding force by deformation and material compression. If the vehicle is hit in the left or right corner, one of the rings will be pushed directly, deformed and compressed to reduce the colliding force. In both situation, the reduced colliding force will be passed to the chassis. If the collision is not heavy, there should be no any damage to both vehicle and driver. If the collision is heavy, it might cause the vehicle turning back. It might still trigger the vehicle to pop up the airbag. In any case, it will significantly reduce the damage to the vehicle and driver.

In accordance with the present invention, this equipment can be installed on front, rear, side or corner of the vehicle with similar design architecture. The equipment can be installed in front of or behind the existing bumper without change in the vehicle. The equipment can also be installed with the existing side pedal. Some vehicles might need to change the bumper, pedal, chassis and frame design to attach the equipment properly.

In accordance with the present invention, the equipment can have multiple rings with different size. The rings of big size will be deformed and compressed first. Such kind of combination will reduce the colliding force smoothly.

In accordance with the present invention, the equipment can have multiple rings with different material. The rings of big size should use the stretchy material that is easily compressed. The rings of small size should use the material with high stiffness and tensile strength. Such kind of combination will reduce the colliding force smoothly.

### BRIEF DESCRIPTION OF THE DRAWINGS

There are five figures in the attached drawings.

FIG. 1 provides the 3-D view of the bumper that is fixed to the vehicle chassis on one end and has the rings installed at front.

FIG. 2 provides the 3-D view of the rings that are fixed by two plates.

FIG. 3 provides the vertical view of the safe protection equipment that is fixed to the vehicle chassis. The safe equipment is installed behind or in front of a bumper, but the bumper is not necessary to utilize the safe equipment.

FIG. 4 provides the vertical view of the safe protection equipment that has different size of rings.

FIG. 5 provides the vertical view of the safe protection equipment that has different size of rings with another type of design.

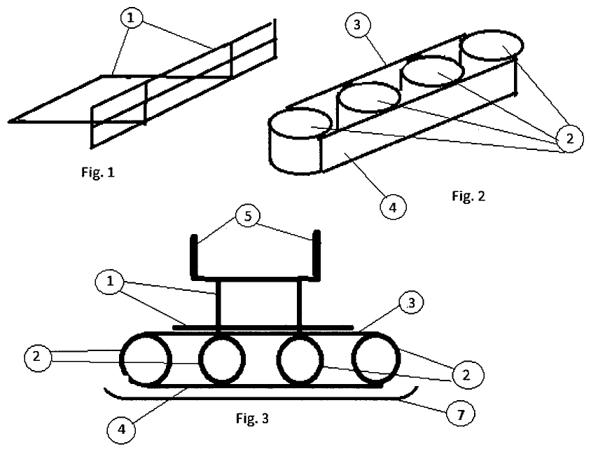

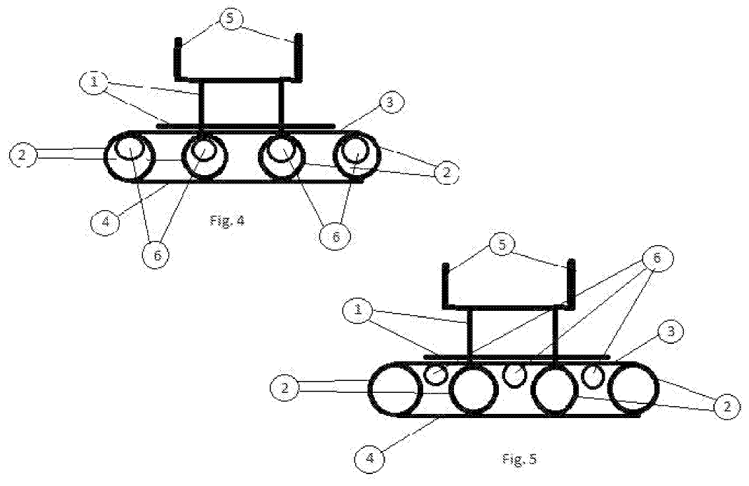

Following are the detailed information about the primary components of the equipment.

1. Tube or bar that constructs the frame. The frame is attached to the chassis of a vehicle on one end and holds the rings on another end.

2. Ring: It has high elasticity. The material of the ring can be rubber, alloy steel or carbon fiber that has high strength. The safe protection equipment uses multiple rings. Outer ring uses more stretchable material than the inner ring does.

3. Back plate that fixes the rings on one side and is fixed to the frame on other side.

4. Front plate that fixes the rings.

5. Vehicle chassis that attaches the frame.

6. Small size ring.

7. Bumper.

Note: Unless specified, most parts are tubes or bars. The size needs further experiment based on the type and size of vehicles.

### DETAILED DESCRIPTION OF PREFERRED EMBODIMENTS

This equipment can be applied to all type of vehicles, e.g., cars, vans and trucks. The material of the ring (3) needs to be sponge or rubber or similar stretchable material, alloy steel or carbon fibers or other similar material with high strength. The size of equipment needs further experiment based on the vehicle. The front of the frame (1) can be designed in different ways such as plate or combination of tube or bar. The equipment can contain rings (3) with different size, the rings (3) with big size will be deformed and compressed first. For some vehicles, the frame (1) is attached to the existing chassis (5) and the existing bumper (7) can be utilized in that the safe equipment is installed behind the bumper (7), which may need to be modified. For other vehicles, the chassis (5) of the vehicle need some design change or strength enhancement. The safe equipment can also fully replace the existing bumper (7) with proper design.

When the vehicle hit an obstacle or two vehicles collide with each other in straight line or almost straight line, the front plate (4) will push the rings al (2). The rings (3) will push the frame (1) through the back plate (2). If the vehicle is hit at the left or right corner, one of the rings (3) will be pushed directly. During this process, the rings (3) will be deformed and the material will be compressed to reduce the colliding force. The reduced force will be passed to the chassis (5) by the frame (1). If the colliding is very heavy, it will also trigger the vehicle to pop up the airbag. In any case, the damage of the vehicle and the driver from the collision accidents will be reduced significantly.

1. Rings comprising:
single or multiple rings (3)
front plate (4) that fixes rings (3)
back plate (2) that fixes rings (3) on one side and is fixed to the bumper (1) on other side characterized in that a colliding force hitting on the front plate (4) push the rings Di that push the bumper (1) through back plate (2) thereof the rings (3) will be deformed and compressed to reduce the colliding force that is passed to the chassis (5) that will move the vehicle forward or back hence significantly reduce the damage to the body of the vehicle and the passengers inside the vehicle.

2. The rings as claimed in claim 1 characterized in that a colliding force hitting on a ring (3) in left or right side will push the ring that push the bumper through back plate (2) thereof the ring (3) will be deformed and compressed to reduce the colliding force that is passed to the chassis (5) that will move the vehicle forward or back hence significantly reduce the damage to the body of the vehicle and the passengers inside the vehicle.

3. The rings as claimed in claim 1 characterized in that the combination of rings (3) with small size rings (6) will reduce the colliding force smoothly with the rings (3) of big size being deformed and compressed first.

4. The rings as claimed in claim 1 characterized in that the rings (3) can be applied to front and/or rear and/or side and/or corner of a vehicle.

5. The rings as claimed in claim 1 characterized in that the combination of rings (3) with stretchy materials and small size rings (6) with high stiffness and tensile strength will reduce the colliding force smoothly with the rings (3) of big size being deformed and compressed first.
